(19) United States
(12) Patent Application Publication
(10) Pub. No.: US 2018/0275921 A1
(43) Pub. Date: Sep. 27, 2018

(54) STORAGE DEVICE

(71) Applicant: Toshiba Memory Corporation, Tokyo (JP)

(72) Inventors: Toru KATAGIRI, Sagamihara Kanagawa (JP); Takuya HAGA, Yokohama Kanagawa (JP)

(21) Appl. No.: 15/885,229

(22) Filed: Jan. 31, 2018

(30) Foreign Application Priority Data
Mar. 23, 2017 (JP) 2017-057712

(51) Int. Cl. G06F 3/06; G11B 19/04; G06F 12/02; G06F 12/0804

(52) U.S. Cl. CPC G06F 3/0659; G11B 19/044; G06F 12/0246; G06F 12/0804; G06F 3/0611; G06F 3/0676; G06F 3/0604

(57) ABSTRACT

A storage device includes a command storage area in which a command is written, a command issuance notification area in which a notification that a command has been issued is written, a nonvolatile storage device configured to store data, and a controller configured to control an access to the nonvolatile storage device in response to the command from a host. Upon detecting that a first command is written in the command storage area, the controller executes a first step required for execution of the first command before a notification that the first command has been issued is written in the command issuance notification area.

### CROSS-REFERENCE TO RELATED APPLICATION

This application is based upon and claims the benefit of priority from Japanese Patent Application No. 2017-057712, filed Mar. 23, 2017, the entire contents of which are incorporated herein by reference.

### FIELD

Embodiments described herein relate generally to a storage device.

### BACKGROUND

In a memory device, for example, a semiconductor memory device having a nonvolatile semiconductor memory, miniaturization of semiconductor manufacturing process has advanced, and as a result, performance degradation has become a problem due to the increase in read time of data from memory cells and the increase in program time of data into memory cells.

### DESCRIPTION OF THE DRAWINGS

FIG. 1 is a block diagram illustrating the configuration of a storage device according to a first embodiment.

FIG. 2 is a view for explaining various functional units realized by executing firmware according to the first embodiment.

FIGS. 3A to 3C are views for explaining various units of data employed in the first embodiment.

FIG. 4 is a view illustrating the configuration of a NAND memory according to the first embodiment.

FIGS. 5A and 5B are views for explaining a read operation according to the first embodiment.

FIGS. 6A and 6B are views for explaining a write operation according to the first embodiment.

FIG. 7 is a block diagram illustrating the configuration of a host interface control unit according to the first embodiment.

FIG. 8 is a view for explaining an address map according to the first embodiment.

FIGS. 9A and 9B are views for explaining issuance of a command from a host according to the first embodiment.

FIGS. 10A and 10B are views for explaining a command completion report to a host according to the first embodiment.

FIGS. 11A to 11C are views for explaining an execution protocol of a command according to the first embodiment.

FIG. 12 is a view for explaining a method of executing a read command according to the first embodiment.

FIG. 13 is a flowchart for explaining an execution procedure of a read command according to a second embodiment.

FIG. 14 is a view for explaining an example of a flow of data at the time of executing a write command according to the second embodiment.

FIG. 15 is a view for explaining another example of the flow of data at the time of executing the write command according to the second embodiment.

FIG. 16 is a view for explaining a method of executing a flush command according to the second embodiment.

FIG. 17 is a flowchart for explaining an execution procedure of the flush command according to the second embodiment.

FIGS. 18A and 18B are views for explaining a read-modify-write process according to a third embodiment.

FIG. 19 is a view for explaining a method of executing a write command according to the third embodiment.

FIG. 20 is a flowchart for explaining an execution procedure of the write command according to the third embodiment.

FIG. 21 is a view for explaining an example of command rewrite according to a fourth embodiment.

FIG. 22 is a view for explaining another example of the command rewrite according to the fourth embodiment.

FIG. 23 is a view for explaining an example of limitation of early execution of a command according to the fourth embodiment.

### DETAILED DESCRIPTION

Embodiments provide a storage device with improved performance.

In general, according to one embodiment, a storage device includes a command storage area in which a command is written, a command issuance notification area in which a notification that has a command has been issued is written, a nonvolatile storage device configured to store data, and a controller configured to control an access to the nonvolatile storage device in response to the command from a host. Upon detecting that a first command is written in the command storage area, the controller executes a first step required for execution of the first command before a notification that the first command has been issued is written in the command issuance notification area.

Hereinafter, a storage device according to some embodiments will be described with reference to the drawings. In the following description, elements having the same function and configuration are denoted by the same reference numerals.

### First Embodiment

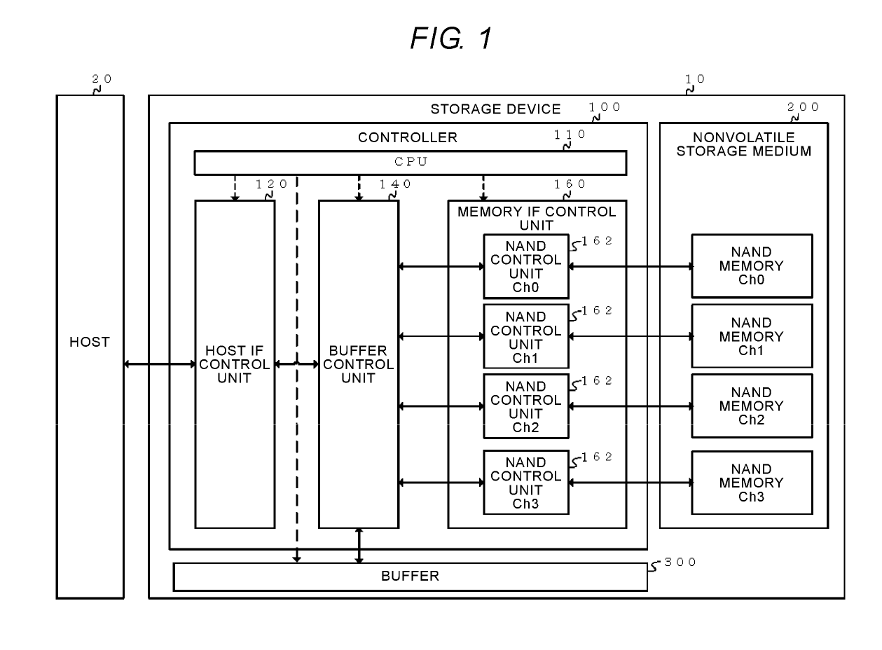

FIG. 1 is a block diagram illustrating the configuration of a storage device according to the first embodiment.

A storage device 10 is connected to a host 20 for communication with the host 20. The storage device 10 includes a controller 100, a nonvolatile storage medium 200, and a buffer 300.

The controller 100 communicates with the host 20 and controls the entire operation of the storage device 10. The controller 100 is a semiconductor integrated circuit configured as an SoC (System-on-a-Chip), for example.

In the description of the present embodiment, the host 20 is a computer that supports an interface conforming to the NVMe (NVM Express®) standard, but the present disclosure is not limited thereto.

The host 20 uses, for example, an LBA (Logical Block Address) as a logical address when reading or writing data from/in the storage device 10. For example, the LBA is a logical address that is given a number starting from 0 and is assigned to a sector (having a size of, e.g., 512 B). In addition, the host 20 may use a key as a logical address. The storage device 10 associates the logical address with a physical address of the nonvolatile storage medium 200 using a logical-to-physical address conversion table (not illustrated).

The nonvolatile storage medium 200 stores data in a nonvolatile (i.e., non-transitory) manner. The nonvolatile storage medium 200 of this embodiment is a NAND flash memory, but is not limited thereto. For example, the nonvolatile storage medium 200 may be a nonvolatile semiconductor memory such as a three-dimensional structure flash memory, a NOR type flash memory, or an MRAM (Magneto-resistive Random Access Memory), or a disk medium such as a magnetic disk or an optical disc. In the following description, the nonvolatile storage medium 200 may be sometimes referred to as NAND memory 200.

The storage device 10 of the present embodiment has a 4-channel (Ch) NAND memory 200. The controller 100 may control the NAND memories 200, which are connected to the respective channels, in parallel. A plurality of NAND memories 200, that is, a plurality of memory chips, may be connected to one channel. Hereinafter, the NAND memories 200 connected to the respective channels will be referred to as NAND memories Ch0 to Ch3, respectively. The number of channels may be larger or smaller than four.

The buffer 300 stores data in a volatile (i.e., transitory) manner. The data stored in the buffer 300 includes (1) data received from the host 20, (2) data read from the NAND memory 200, and (3) information required by the controller 100 to control the storage device 10, and the like.

The buffer 300 of the present embodiment is a DRAM (Dynamic Random Access Memory), but may be other types of general-purpose memories such as an SRAM (Static Random Access Memory). The buffer 300 may be incorporated in the controller 100.

The controller 100 includes a CPU (Central Processing Unit) 110, a host interface (IF) control unit 120, a buffer control unit 140, and a memory interface (IF) control unit 160.

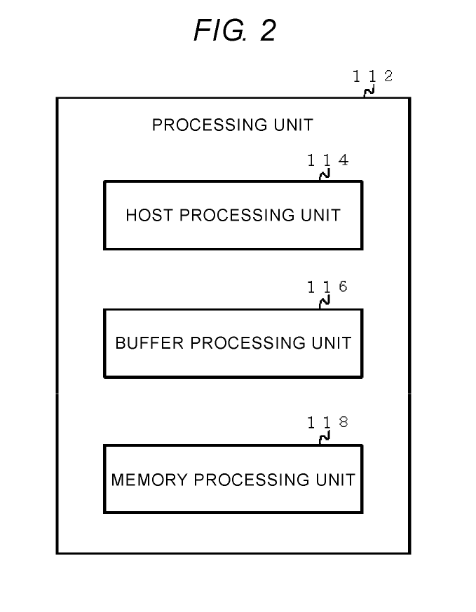

The CPU 110 controls the entire storage device 10 based on FW (Firmware). FIG. 2 is a view illustrating various functional units realized by the CPU 110 executing the FW. The CPU 110 functions as a processing unit 112 that controls the entire storage device 10. The processing unit 112 includes a host processing unit 114, a buffer processing unit 116, and a memory processing unit 118. The host processing unit 114 primarily controls the host IF control unit 120. The buffer processing unit 116 primarily controls the buffer control unit 140. The memory processing unit 118 primarily controls the memory IF control unit 160.

The CPU 110 may not be incorporated in the controller 100, and may be a separate semiconductor integrated circuit. In addition, in the following description, some or all of the functions described to be executed by the FW may also be executed by dedicated HW (Hardware), and some or all of the functions described to be executed by HW may also be executed by the FW.

Returning back to FIG. 1, the description will be continued.

The host IF control unit 120 interprets and executes a command received from the host 20. A detailed configuration of the host IF control unit 120 will be described later.

The buffer control unit 140 performs control of write/read of data in/from the buffer 300, management of empty areas of the buffer 300, and the like.

The memory IF control unit 160 includes a plurality of NAND control units 162. The NAND control units 162 are respectively connected to the NAND memories Ch0 to Ch3 (hereinafter, sometimes referred to as NAND control units Ch0 to Ch3). The NAND control units 162 control operations such as write, read, erase, and so on of data with respect to the NAND memory 200.

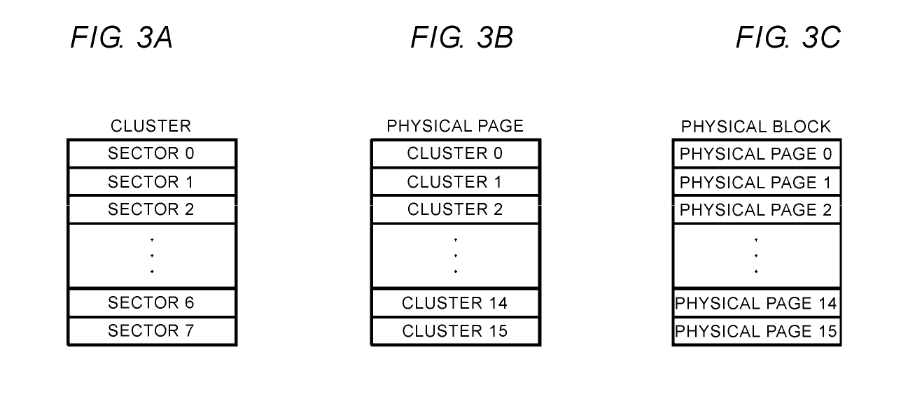

Next, various units of data employed in the present embodiment will be described with reference to FIGS. 3A to 3C.

As illustrated in FIG. 3A, the minimum unit for managing read/write of data from/in the NAND memory 200 is called a cluster. In the present embodiment, the size of the cluster is 4 kB. One cluster contains, for example, data of 8 sectors.

As illustrated in FIG. 3B, the minimum unit of reading and writing data by a circuit in the NAND memory 200 is called a physical page. In the present embodiment, the size of the physical page is 16 clusters (4 kB×16 clusters=64 kB).

As illustrated in FIG. 3C, the minimum unit of erasing data by a circuit in the NAND memory 200 is called a physical block. In the present embodiment, the size of the physical block is 16 physical pages (64 kB×16 physical pages=1024 kB).

The size of each of these units is given byway of example, and is not limited thereto.

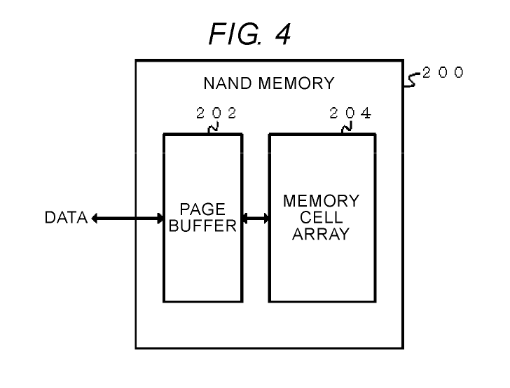

Next, the configuration of the NAND memory 200 according to the present embodiment will be described with reference to FIG. 4.

The NAND memory 200 includes a page buffer 202 and a memory cell array 204. The page buffer 202 temporarily stores data. The memory cell array 204 stores data in a nonvolatile manner.

In the present embodiment, the size of the page buffer 202 is equal to the size of data of one physical page. That is, the size of the page buffer 202 is 16 clusters (64 kB). The data stored in the page buffer 202 may be written (also referred to as programmed) in the memory cell array 204 one physical page at a time. In addition, data read from the memory cell array 204 may be stored in the page buffer 202 one physical page at a time.

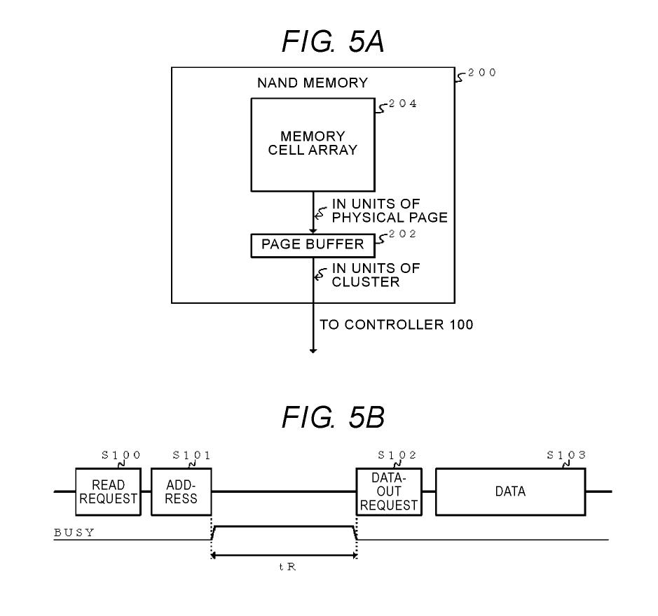

Next, an operation of read from the NAND memory 200 in the present embodiment will be described with reference to FIGS. 5A and 5B.

As illustrated in FIG. 5A, the NAND memory 200 reads data from the memory cell array 204 in units of physical page. The NAND memory 200 stores the read data in the page buffer 202. The NAND memory 200 outputs the read data stored in the page buffer 202 to the controller 100 in units of cluster. The controller 100 stores the read data in the buffer 300.

FIG. 5B is a timing chart of the read operation.

In order to request the NAND memory 200 to perform the read operation, the controller 100 issues a read request (S100). Next, the controller 100 inputs an address of a read target to the NAND memory 200 (S101). The NAND memory 200 reads the target data from the memory cell array 204 over time tR and stores the read data in the page buffer 202. Meanwhile, the NAND memory 200 asserts a BUSY signal to the controller 100.

When the BUSY signal is negated (i.e., no longer asserted), the controller 100 issues a data-out request to the NAND memory 200 (S102). Upon receiving the data-out request, the NAND memory 200 outputs the data stored in the page buffer 202 to the controller 100 (S103).

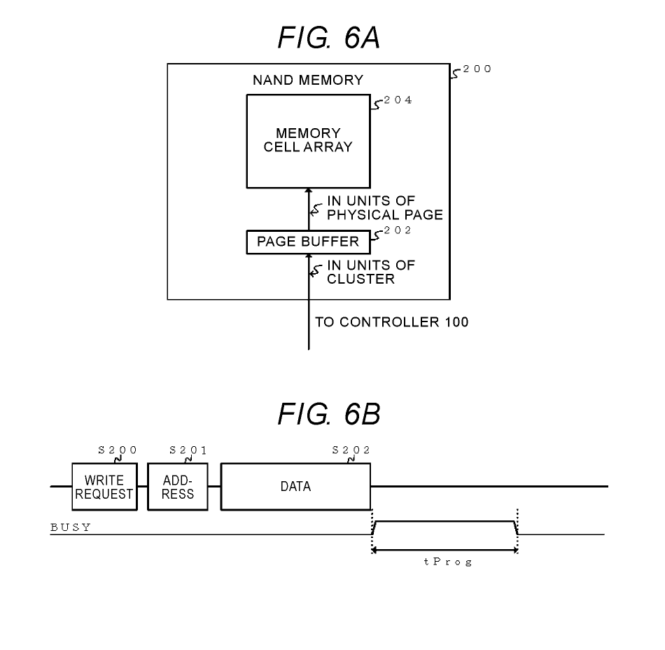

Next, an operation of write in the NAND memory 200 in the present embodiment will be described with reference to FIGS. 6A and 6B.

As illustrated in FIG. 6A, the controller 100 writes data in the page buffer 202 in units of cluster. The NAND memory 200 writes the written data stored in the page buffer 202 in the memory cell array 204 in units of physical page.

FIG. 6B is a timing chart of the write operation.

In order to request the NAND memory 200 to perform the write operation, the controller 100 issues a write request (S200). Next, the controller 100 inputs an address of a write target to the NAND memory 200 (S201). Next, the controller 100 writes the write data in the page buffer 202 (S202).

The NAND memory 200 writes the target data in the memory cell array 204 over time tProg. Meanwhile, the NAND memory 200 asserts a BUSY signal to the controller 100.

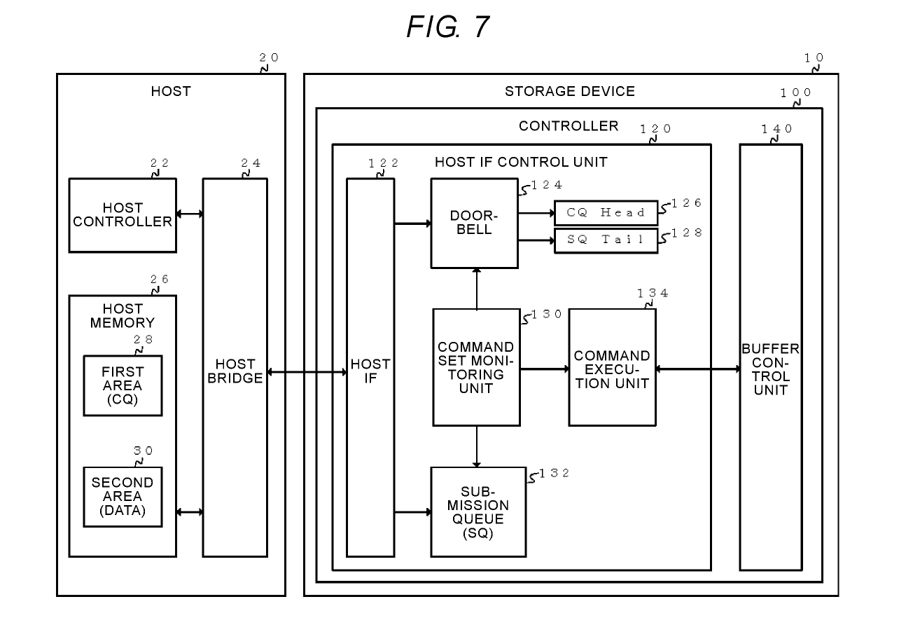

Next, the configurations of the host 20 and the host IF control unit 120 according to the present embodiment will be described with reference to FIG. 7.

The host 20 includes a host controller 22, a host bridge 24, and a host memory 26.

The host controller 22 and the host memory 26 are connected to the host bridge 24.

The host controller 22 performs various controls for the host 20.

The host memory 26 stores data generated by the host controller 22, data exchanged with peripheral devices, and the like. The host memory 26 includes a first area and a second area. The first area includes a completion queue (CQ) 28. The completion queue 28 stores completion information of a command for which the storage device 10 has completed its execution. The completion queue 28 of the present embodiment includes eight areas (CQ #0 to CQ #7) for storing command completion information, but the present disclosure isnot limited thereto. The second area includes a host data buffer 30. The host data buffer 30 is used for data transfer with the storage device 10.

The host bridge 24 has an interface to which a peripheral device such as the storage device 10 is connected. An example of this interface may include an NVMe interface.

The host IF control unit 120 includes a host interface (IF) 122, a doorbell 124, a CQ Head pointer 126, an SQ Tail pointer 128, a command set monitoring unit 130, a submission queue (SQ) 132, and a command execution unit 134.

The host IF 122 is connected to the host bridge 24. The host IF 122 serves as an interface for access from the host 20 to the doorbell 124 and the submission queue 132.

The submission queue (SQ) 132 is configured with, for example, an SRAM. The submission queue 132 may be a DRAM or a register. The host 20 writes a command in the submission queue 132. That is, the submission queue 132 functions as a command storage area. Although the submission queue 132 of the present embodiment includes eight areas (SQ #0 to SQ #7) for storing commands, the present disclosure is not limited thereto.

The host 20 operates the CQ Head pointer 126 and the SQ Tail pointer 128 by writing the doorbell 124. Each of the CQ Head pointer 126 and the SQ Tail pointer 128 is configured with, for example, a register and a logic circuit such as an adder circuit, but is not limited thereto. The host 20 operates the CQ Head pointer 126 when receiving the command completion information. The host 20 operates the SQ Tail pointer 128 when issuing a command. Details thereof will be described later.

The command set monitoring unit 130 monitors write of a command in the submission queue 132. The command execution unit 134 executes a command based on a protocol adopted to a communication interface with the host 20. Further, the command execution unit 134 exchanges data with the buffer control unit 140.

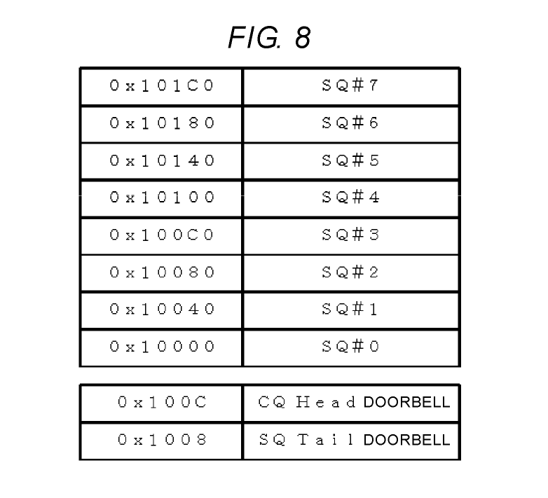

The storage device 10 permits the host 20 to access the doorbell 124 and the submission queue 132. FIG. 8 is a view for explaining an address map according to the present embodiment.

The host 20 may access the doorbell 124 by accessing an address=0x1008 or an address=0x100C. The host 20 can operate the SQ Tail pointer 128 by accessing the address=0x1008. The address=0x1008 is also called an SQ Tail doorbell. The host 20 can operate the CQ Head pointer 126 by accessing the address=0x100C. The address=0x100C is also called a CQ Head doorbell.

The host 20 may access the first command area (SQ #0) of the submission queue 132 by accessing an address=0x10000. Similarly, the host 20 may access the second to eighth command areas (SQ #1 to SQ #7) of the submission queue 132 by accessing addresses=0x10040 to 0x101C0, respectively.

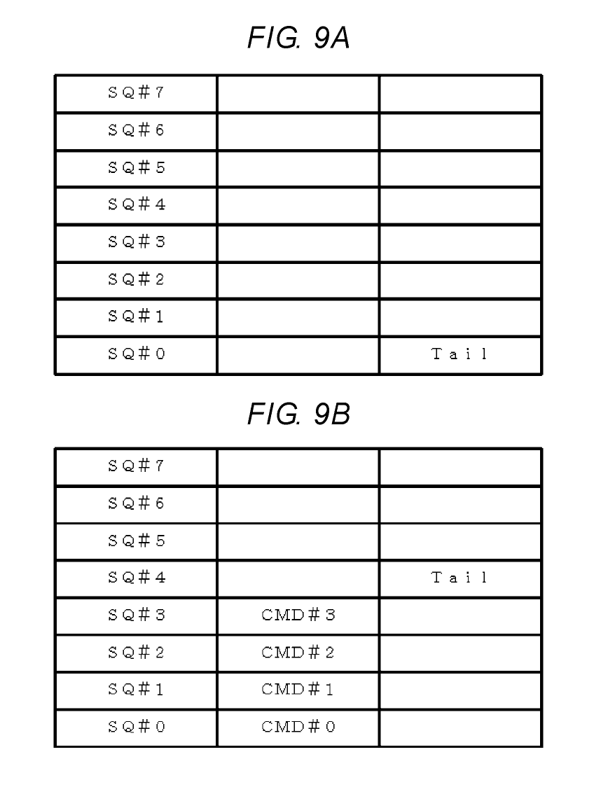

Next, issuance of a command from the host according to the present embodiment will be described with reference to FIGS. 9A and 9B.

FIG. 9A illustrates the state of the submission queue 132 before issuing a command. No command is stored in any of SQ #0 to SQ #7. In addition, the SQ Tail pointer 128 indicates SQ #0.

FIG. 9B illustrates the state after the host 20 issues four commands CMD #0 to CMD #3. The commands CMD #0 to CMD #3 are stored in SQ #0 to SQ #3, respectively. The host 20 operates the SQ Tail pointer 128 by writing a value of the SQ Tail pointer 128 in the SQ Tail doorbell. Here, it is assumed that the host 20 writes in the SQ Tail doorbell a value of the SQ Tail pointer 128 to point to SQ #4. When the SQ Tail pointer 128 indicates SQ #4, CMD #0 to CMD #3 stored in SQ #0 to SQ #3 become valid so that the storage device 10 can start execution of each command. That is, the operation of the SQ Tail pointer 128 via the SQ Tail doorbell functions as a command issue notification.

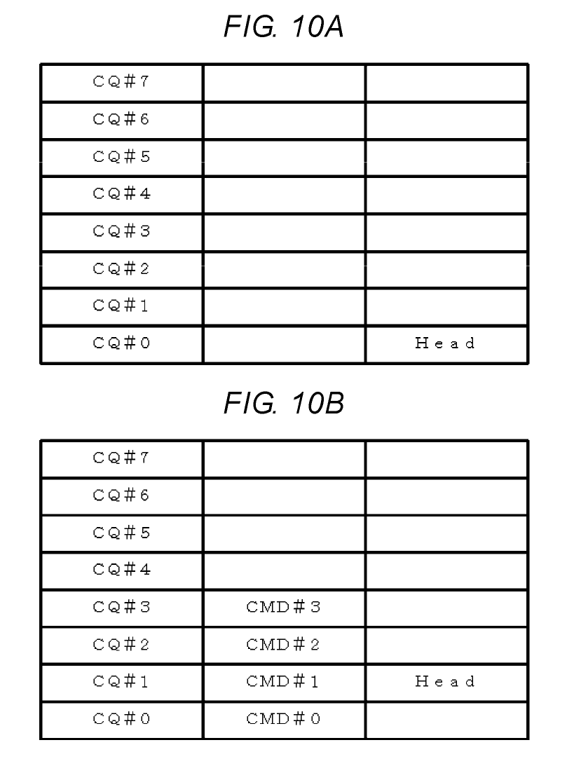

Next, command execution completion report to the host according to the present embodiment will be described with reference to FIGS. 10A and 10B.

FIG. 10A illustrates the state of the completion queue 28 before a command execution completion is reported. No command completion information is stored in any of CQ #0 to CQ #7. In addition, the CQ Head pointer 126 indicates CQ #0.

When the execution of a command is completed, the storage device 10 writes command completion information in the completion queue 28. FIG. 10B illustrates a state after the storage device 10 writes command completion information of four commands CMD #0 to CMD #3. CMD #0 to CMD #3 are stored in CQ #0 to CQ #3, respectively. Upon writing the command completion information in the completion queue 28, the storage device 10 notifies the host 20 of an interrupt.

Upon receiving the notification of the interrupt, the host 20 reads the completion queue 28 to acquire the command completion information. Then, the host 20 operates the CQ Head pointer 126 by writing a value of the CQ Head pointer 126 in the CQ Head doorbell. Here, it is assumed that the host 20 writes in the CQ Head doorbell a value of the CQ Head pointer 126 to point to CQ #1. When the CQ Head pointer 126 indicates CQ #1, the storage device 10 can recognize that the host 20 has acquired the command completion information of CMD #0 stored in CQ #0.

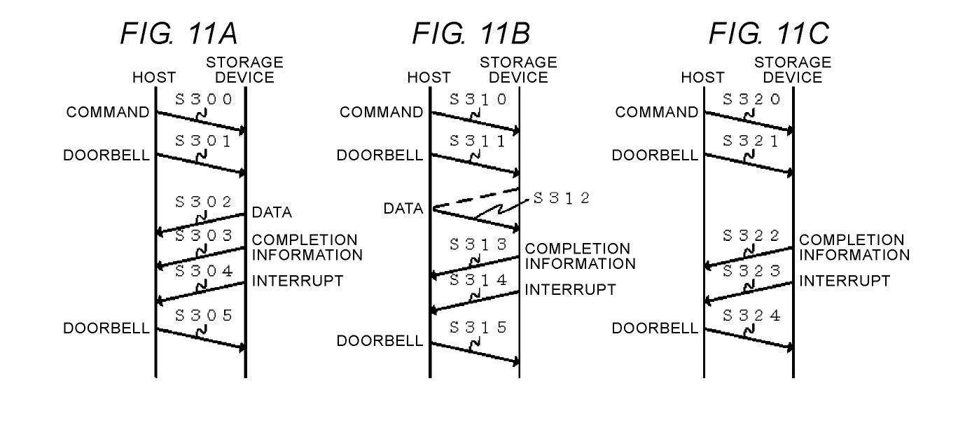

Next, execution protocols of commands according to the present embodiment will be described with reference to FIGS. 11A to 11C. In the present embodiment, the storage device 10 executes various commands based on execution protocols conforming to the NVMe standard.

FIG. 11A is a view for explaining the protocol of a read command.

The host 20 issues a read command to the storage device 10 (S300). More specifically, the host 20 writes the read command in the submission queue 132. Next, the host 20 writes a value of the SQ Tail pointer 128 in the SQ Tail doorbell and notifies the storage device 10 of the issuance of the read command (S301). The read command includes a start LBA, the number of transfers, and an address of the host data buffer 30 that is to store read data.

The storage device 10 transfers the read data designated by the start LBA and the number of transfers to the host 20 (S302). At this time, the storage device 10 writes the read data in the host data buffer 30 corresponding to the address designated by the read command. When the write of the read data in the host data buffer 30 is completed, the storage device 10 writes completion information of the read command in the completion queue 28 (S303). Next, the storage device 10 notifies the host 20 of an interrupt (S304). Upon receiving the notification of the interrupt, the host 20 acquires the completion information of the read command from the completion queue 28. The host 20 writes a value of the CQ Head pointer 126 in the CQ Head doorbell and notifies the storage device 10 that the completion information of the read command has been acquired (S305).

FIG. 11B is a view for explaining the protocol of a write command.

The host 20 issues a write command to the storage device 10 (S310). More specifically, the host 20 writes the write command in the submission queue 132. Next, the host 20 writes a value of the SQ Tail pointer 128 in the SQ Tail doorbell and notifies the storage device 10 of the issuance of the write command (S311). The write command includes a start LBA, the number of transfers, and an address of the host data buffer 30 that stores write data.

The storage device 10 fetches the write data from the host data buffer 30 corresponding to the address designated by the write command (S312). When the fetch of the write data designated by the start LBA and the number of transfers is completed, the storage device 10 writes completion information of the write command in the completion queue 28 (S313). Next, the storage device 10 notifies the host 20 of an interrupt (S314). Upon receiving the notification of the interrupt, the host 20 acquires the completion information of the write command from the completion queue 28. The host 20 writes a value of the CQ Head pointer 126 in the CQ Head doorbell and notifies the storage device 10 that the completion information of the write command has been acquired (S315).

FIG. 11C is a view for explaining the protocol of a non-data command.

The host 20 issues a non-data command to the storage device 10 (S320). More specifically, the host 20 writes the non-data command in the submission queue 132. Next, the host 20 writes a value of the SQ Tail pointer 128 in the SQ Tail doorbell and notifies the storage device 10 of the issuance of the non-data command (S321).

When the operation specified by the non-data command is completed, the storage device 10 writes completion information of the non-data command in the completion queue 28 (S322). Next, the storage device 10 notifies the host 20 of an interrupt (S323). Upon receiving the notification of the interrupt, the host 20 acquires the completion information of the non-data command from the completion queue 28. The host 20 writes a value of the CQ Head pointer 126 in the CQ Head doorbell and notifies the storage device 10 that the completion information of the non-data command has been acquired (S324).

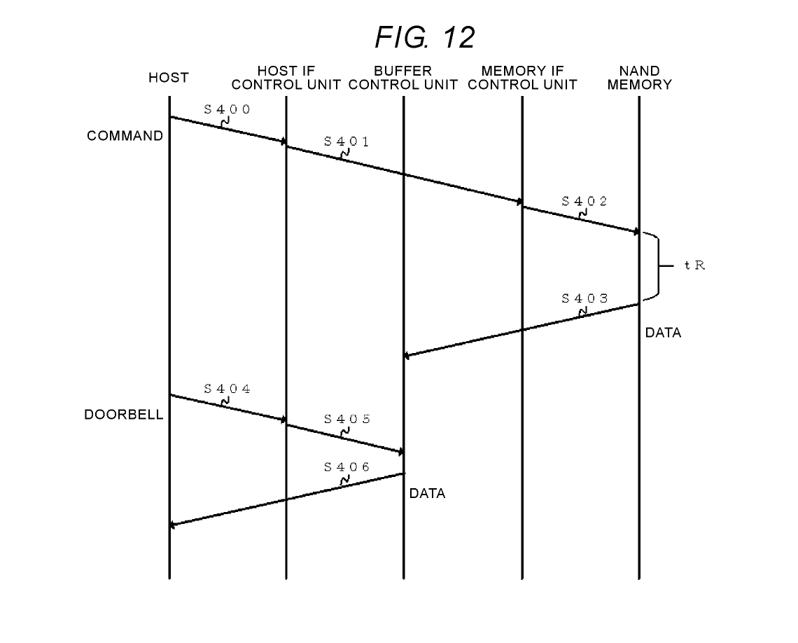

Next, a method of executing the read command according to the present embodiment will be described with reference to FIG. 12. A process after write of the completion information of the read command in the completion queue 28 is not illustrated in FIG. 12.

As described with reference to FIG. 11A, in the protocol of NVMe, the read data cannot be transferred to the host 20 until the SQ Tail doorbell is written and the read command becomes valid. Prior to the write in the SQ Tail doorbell, the storage device 10 of the present embodiment starts in advance an execution step required to execute the read command.

The host 20 issues a read command to the storage device 10 (S400). More specifically, the host 20 writes the read command in the submission queue 132.

By monitoring an address of access to the host IF 122, the command set monitoring unit 130 can detect that a command has been written in the submission queue 132. Upon detecting that the command has been written, the command set monitoring unit 130 notifies the host processing unit 114 that the command has been written. Upon receiving the notification, the host processing unit 114 acquires the command from the submission queue 132. The host processing unit 114 interprets the contents of the command and sends an instruction required for the operation of the read command to the host IF control unit 120 (more specifically, the command execution unit 134). Upon receiving the instruction, the host IF control unit 120 requests the memory IF control unit 160 to read data (S401).

Upon receiving the request, the memory IF control unit 160 outputs a read request and a read address to the NAND memory 200 (S402). After time tR, the NAND memory 200 outputs read data to the buffer control unit 140 (S403). The buffer control unit 140 stores the read data in the buffer 300.

When the host 20 writes the SQ Tail doorbell and operates the SQ Tail pointer 128, the read command becomes valid (S404). The command set monitoring unit 130 notifies the host processing unit 114 that the read command has been valid. Upon receiving the notification, the host processing unit 114 sends an instruction required for data read from the buffer 300 and for data transfer to the host 20 to the host IF control unit 120 (more specifically, the command execution unit 134). Upon receiving the instruction, the host IF control unit 120 requests the buffer control unit 140 to transfer the read data (S405). The host IF control unit 120 writes the read data read from the buffer 300 in the host data buffer 30 (S406).

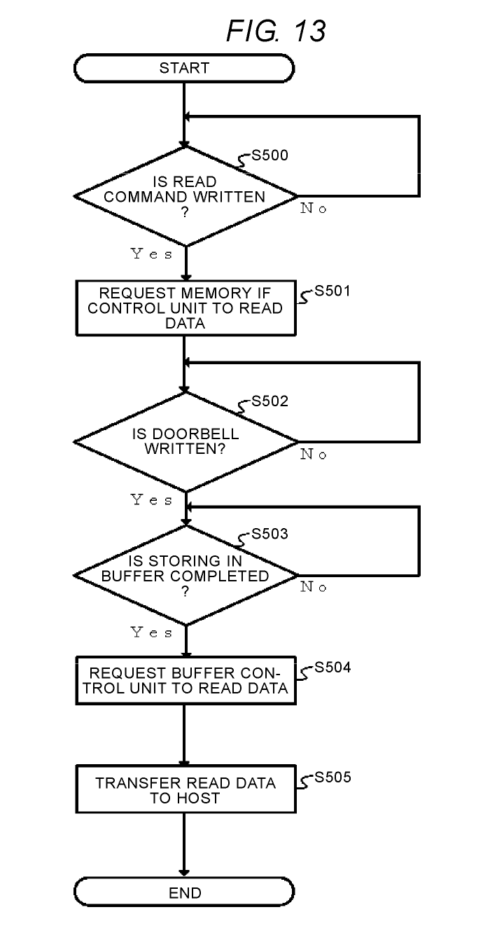

Next, an execution procedure of a read command according to this embodiment will be described with reference to FIG. 13.

The host IF control unit 120 monitors whether or not a read command is written in the submission queue 132 (S500). When the read command is written (Yes in S500), the host IF control unit 120 requests the memory IF control unit 160 to read data (S501) according to an instruction from the host processing unit 114.

Next, the host IF control unit 120 monitors whether or not the SQ Tail doorbell is written (S502). When the SQ Tail doorbell is written, that is, when the SQ Tail pointer 128 is operated and the read command becomes valid (Yes in S502), the buffer processing unit 116 checks whether or not the required read data is stored in the buffer 300 (S503). When storage of the read data in the buffer 300 is completed (Yes in S503), the host IF control unit 120 requests the buffer control unit 140 to read the read data from the buffer 300 according to an instruction from the host processing unit 114 (S504). Then, the host IF control unit 120 transfers the read data to the host 20 (S505).

According to the storage device of the first embodiment described above, since the read of data from the nonvolatile storage medium is started in advance before read command issuance notification, it is possible to improve the performance of the storage device.

### Second Embodiment

A storage device 10 according to a second embodiment executes an execution step required for execution of a non-data command, for example, a flush command, before command issuance notification.

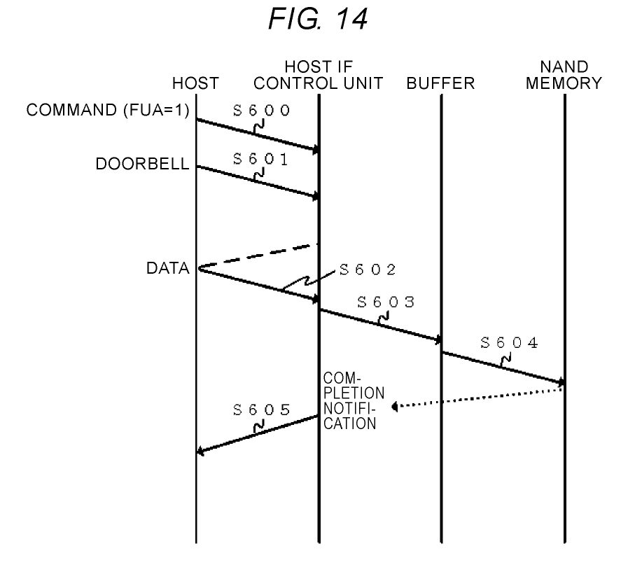

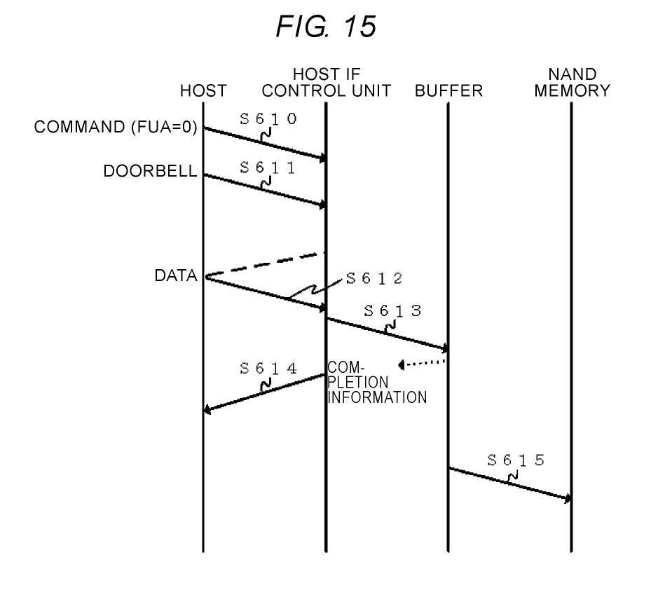

First, a flow of data in the storage device 10 at the time executing a write command will be described with reference to FIGS. 14 and 15. The write command described with reference to FIG. 11B has an attribute value called an FUA (Force Unit Access).

FIG. 14 is a view for explaining a flow of data at the time of executing a write command of FUA=1. A process after interrupt notification is omitted in FIG. 14.

The host 20 issues a write command to the storage device 10 (S600). More specifically, the host 20 writes the write command in the submission queue 132. Next, the host 20 writes a value of the SQ Tail pointer 128 in the SQ Tail doorbell and notifies the storage device 10 of the issuance of the write command (S601).

The storage device 10 fetches write data from the host data buffer 30 corresponding to an address designated by the write command (S602). The storage device 10 stores the fetched write data in the buffer 300 (S603). Further, the storage device 10 writes the write data stored in the buffer 300 in the NAND memory 200 (S604).

When writing of the write data in the NAND memory 200 by the number of transfers designated by the write command is completed, the storage device 10 writes completion information of the write command in the completion queue 28 (S605). When FUA=1, the completion information of the write command has to be written after writing the write data in the NAND memory 200.

FIG. 15 is a view for explaining a flow of data at the time of executing a write command of FUA=0. A process after interrupt notification is also omitted in FIG. 15.

A process up to write command issuance (S610 and S611) is the same as that in FIG. 14, and therefore, the description thereof will be omitted here.

The storage device 10 fetches write data from the host data buffer 30 corresponding to an address designated by the write command (S612). The storage device 10 stores the fetched write data in the buffer 300 (S613).

When storage of the write data in the buffer 300 by the number of transfers designated by the write command is completed, the storage device 10 writes completion information of the write command in the completion queue 28 (S614). When FUA=0, the completion information of the write command may be written before writing the write data in the NAND memory 200.

The write data stored in the buffer 300 is written in the NAND memory 200, for example, at the time of idling of the storage device 10 (S615).

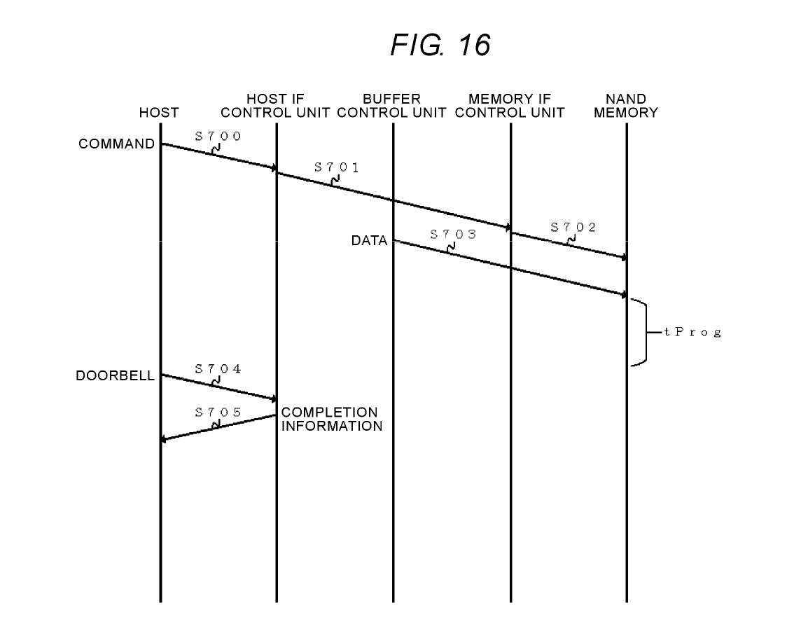

Next, a method of executing a flush command according to the present embodiment will be described with reference to FIG. 16. A flush command is one type of the non-data command described with reference to FIG. 11C. The flush command requests write of the write data, which has been stored in the buffer 300 in response to a write command of FUA=0, into the NAND memory 200. A process after interrupt notification is also omitted in FIG. 16.

The host 20 issues a flush command to the storage device 10 (S700). More specifically, the host 20 writes the flush command in the submission queue 132.

By monitoring an address of access to the host IF 122, the command set monitoring unit 130 can detect that a command has been written in the submission queue 132. Upon detecting that the command has been written, the command set monitoring unit 130 notifies the host processing unit 114 that the command has been written. Upon receiving the notification, the host processing unit 114 acquires the command from the submission queue 132. The host processing unit 114 interprets the contents of the command and sends an instruction required for the operation of the flush command to the host IF control unit 120 (more specifically, the command execution unit 134). Upon receiving the instruction, the host IF control unit 120 requests the memory IF control unit 160 to write the write data stored in the buffer 300 into the NAND memory 200 (S701).

Upon receiving the request, the memory IF control unit 160 outputs a write request and a write address to the NAND memory 200 (S702). Next, the memory IF control unit 160 requests the buffer control unit 140 to transfer the write data stored in the buffer 300. The buffer control unit 140 writes the write data stored in the buffer 300 into the NAND memory 200 (S703). The NAND memory 200 writes the write data in the memory cell array 204 over time tProg.

When the host 20 writes the SQ Tail doorbell and operates the SQ Tail pointer 128, the flush command becomes valid (S704). The command set monitoring unit 130 notifies the host processing unit 114 that the flush command has been valid. Upon receiving the notification, the host processing unit 114 confirms that the write of the write data into the NAND memory 200 has been completed. Then, the host processing unit 114 instructs the host IF control unit 120 to write completion information of the flush command in the host 20 (S705).

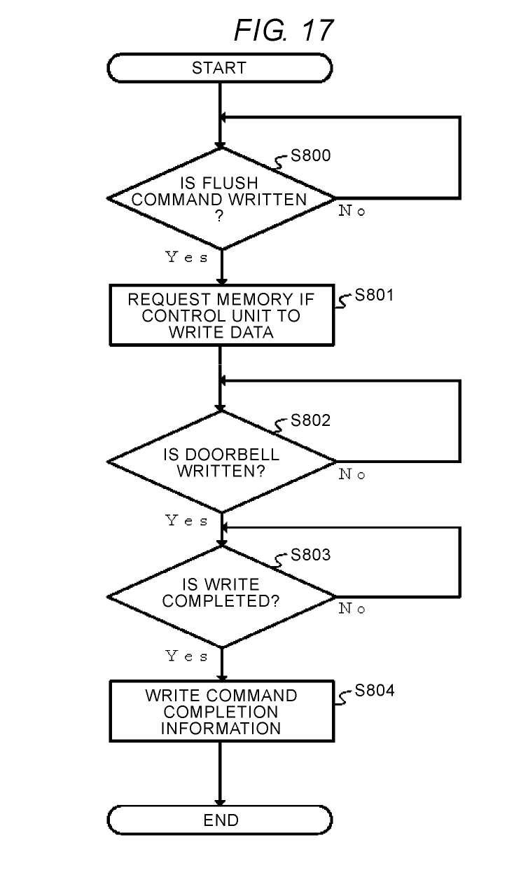

Next, with reference to FIG. 17, a procedure of executing a flush command according to the present embodiment will be described with reference to FIG. 17.

The host IF control unit 120 monitors whether or not a flush command is written in the submission queue 132 (S800). When the flush command is written (Yes in S800), the host IF control unit 120 requests the memory IF control unit 160 to write data according to an instruction from the host processing unit 114 (S801).

Next, the host IF control unit 120 monitors write in the SQ Tail doorbell (S802). When the SQ Tail doorbell is written, that is, when the SQ Tail pointer 128 is operated and the flush command becomes valid (Yes in S802), the host processing unit 114 checks whether or not the write of the write data as a flush target into the NAND memory 200 has been completed (S803). When the write of the write data is completed (Yes in S803), the host IF control unit 120 writes completion information of the flush command in the host 20 according to an instruction from the host processing unit 114 (S804).

According to the storage device of the second embodiment described above, since the operation of write in the nonvolatile storage medium is started in advance before command issuance notification for the flush command, it is possible to improve the performance of the storage device.

### Third Embodiment

A storage device 10 according to a third embodiment executes an execution step required for execution of a write command before command issuance notification.

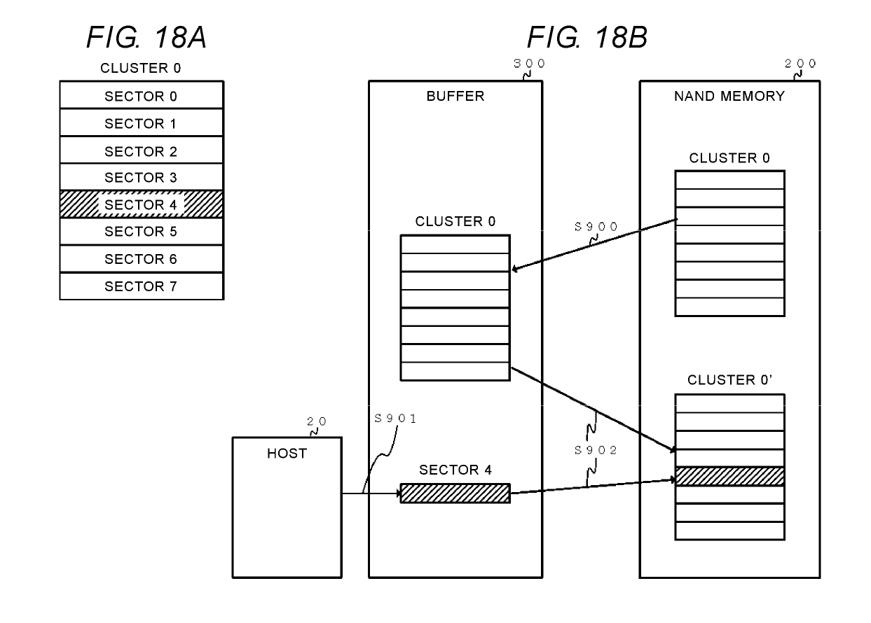

First, a read-modify-write process according to this embodiment will be described with reference to FIGS. 18A and 18B.

As described above, the basic unit of data transfer between the controller 100 and the NAND memory 200 is a cluster, while the basic unit of data transfer between the host 20 and the storage device 10 is a sector.

Here, as illustrated in FIG. 18A, a case where only sector 4 in cluster 0 including sector 0 to sector 7 is rewritten in response to a write command from the host 20 is considered.

In such a case, as illustrated in FIG. 18B, first, the storage device 10 reads data including cluster 0 from the NAND memory 200 and stores the data in the buffer 300 (S900). Next, the storage device 10 receives data of sector 4 from the host 20 and stores the data in the buffer 300 (S901). Then, the storage device 10 merges data other than sector 4 among the data of cluster 0 stored in the buffer 300 in S900 with the data of sector 4 stored in the buffer 300 in S901 and writes the merged data in the NAND memory 200 (S902). Meanwhile, the order of S900 and S901 may be changed.

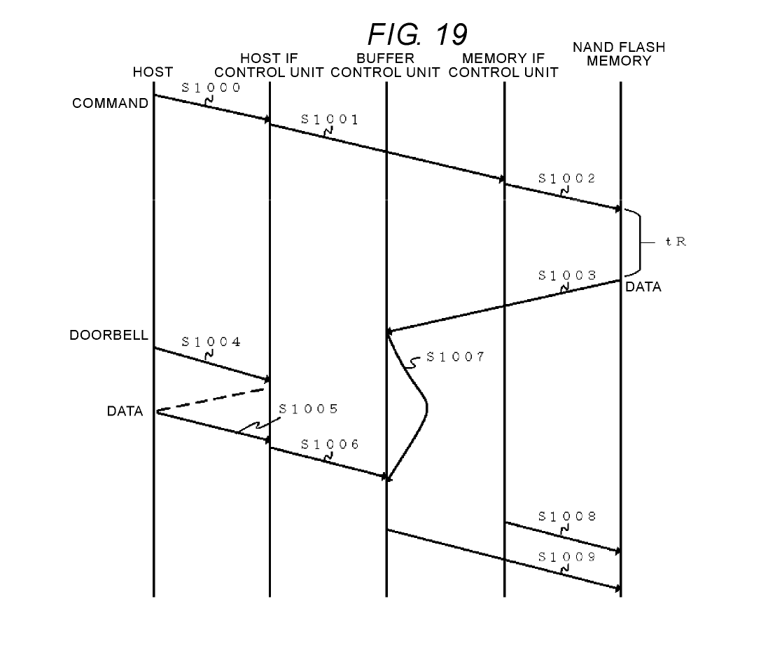

Next, a method of executing the write command according to the present embodiment will be described with reference to FIG. 19. A process after write of the completion information of the write command in the completion queue 28 is omitted in FIG. 19.

As described with reference to FIG. 11B, in the protocol of NVMe, the write data cannot be fetched from the host 20 until the SQ Tail doorbell is written and the write command becomes valid. Prior to write in the SQ Tail doorbell, the storage device 10 of the present embodiment starts with an execution step required for execution of a write command, for example, the above-described read-modify-write process in advance.

The host 20 issues a write command in the storage device 10 (S1000). More specifically, the host 20 writes the write command in the submission queue 132.

By monitoring an access address to the host IF 122, the command set monitoring unit 130 can detect that a command has been written in the submission queue 132. Upon detecting that the command has been written, the command set monitoring unit 130 notifies the host processing unit 114 that the command has been written. Upon receiving the notification, the host processing unit 114 acquires the command from the submission queue 132. The host processing unit 114 interprets the contents of the command. When determining that a read-modify-write process is required, the host processing unit 114 sends an instruction required for the read-modify-write process to the host IF control unit 120 (more specifically, the command execution unit 134). Upon receiving the instruction, the host IF control unit 120 requests the memory IF control unit 160 to read data (S1001).

Upon receiving the request, the memory IF control unit 160 issues a read request and a read address to the NAND memory 200 (S1002). After time tR, the NAND memory 200 outputs read data to the buffer control unit 140 (S1003). The buffer control unit 140 stores the read data in the buffer 300.

When the host 20 writes the SQ Tail doorbell and operates the SQ Tail pointer 128, the write command becomes valid (S1004). The command set monitoring unit 130 notifies the host processing unit 114 that the write command has been valid. Upon receiving the notification, the host processing unit 114 instructs the host IF control unit 120 (more specifically, the command execution unit 134) to fetch data. Upon receiving the instruction, the host IF control unit 120 fetches the data from the host data buffer 30 (S1005).

The buffer control unit 140 stores the data fetched by the host IF control unit 120 in the buffer 300 (S1006). The buffer processing unit 116 merges the data stored in the buffer 300 in S1003 with the data stored in the buffer 300 in S1006 (S1007).

The memory IF control unit 160 outputs a write request and a write address to the NAND memory 200 (S1008). Next, the memory IF control unit 160 requests the buffer control unit 140 to transfer the merged data. The buffer control unit 140 writes the merged data stored in the buffer 300 into the NAND memory 200 (S1009).

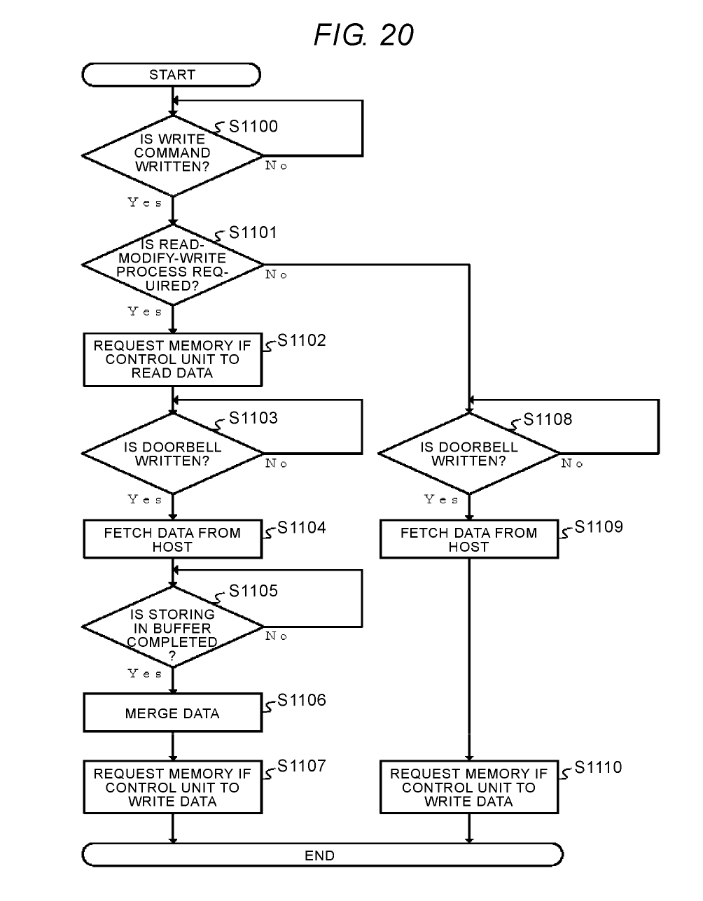

Next, an execution procedure of a write command according to this embodiment will be described with reference to FIG. 20.

The host IF control unit 120 monitors whether or not a write command is written in the submission queue 132 (S1100). When the write command is written (Yes in S1100), the host processing unit 114 determines whether or not a read-modify-write process is required (S1101).

When the read-modify-write process is required (Yes in S1101), the host IF control unit 120 requests the memory IF control unit 160 to read data (S1102) according to an instruction from the host processing unit 114.

Next, the host IF control unit 120 monitors write in the SQ Tail doorbell (S1103). When the SQ Tail doorbell is written, that is, when the SQ Tail pointer 128 is operated and the write command becomes valid (Yes in S1103), the host IF control unit 120 fetches write data from the host data buffer 30 according to an instruction from the host processing unit 114 (S1104).

Next, the buffer processing unit 116 checks whether or not data required for the read-modify-write process has been stored in the buffer 300 (S1105). When the storage of the required data in the buffer 300 is completed (Yes in S1105), the buffer processing unit 116 merges the data on the buffer 300 (S1106).

Then, the buffer processing unit 116 and the memory processing unit 118 respectively request the buffer control unit 140 and the memory IF control unit 160 to write the merged data in the NAND memory 200 (S1107).

On the other hand, when the read-modify-write process is not required (No in S1101), there is no process that can be performed in advance until the SQ Tail doorbell is written and the write command becomes valid. In this case, after the write command becomes valid (S1108), write data is fetched from the host data buffer 30 (S1109), and data is written in the NAND memory 200 (S1110).

According to the storage device of the third embodiment described above, since data required for the read-modify-write process begins to be read from the nonvolatile storage medium in advance before command issuance notification for a write command, it is possible to improve the performance of the storage device.

### Fourth Embodiment

A storage device 10 according to a fourth embodiment performs an appropriate process when a command, for which execution has been started in advance before command issue notification, is rewritten.

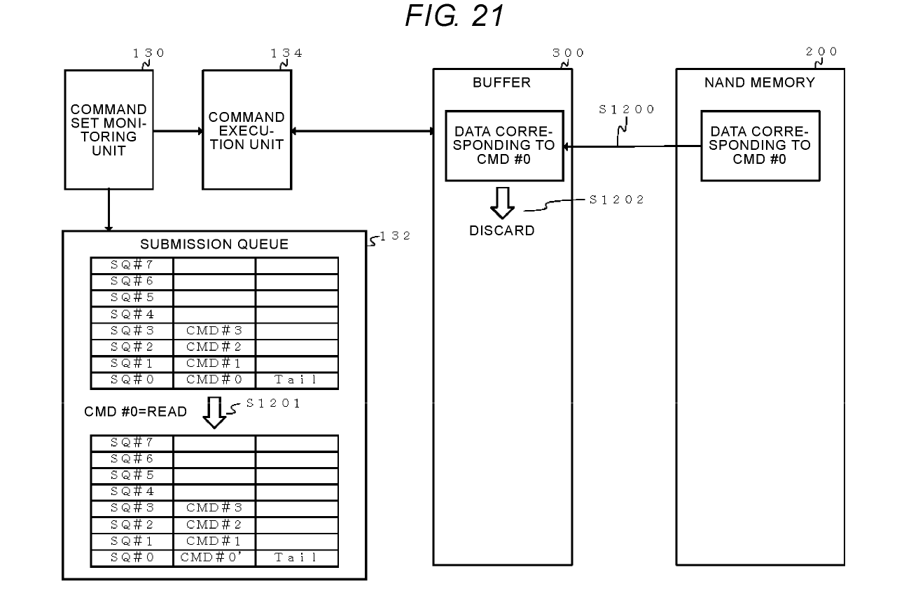

In an example illustrated in FIG. 21, as described in the first embodiment, in regard to CMD #0 (read command) stored in SQ #0 of the submission queue 132, the corresponding data is stored in the buffer 300 before the SQ Tail doorbell is written (S1200).

At this time, a case where the host 20 rewrites a command of SQ #0 into another command CMD #0′ is considered. In the case where said another command CMD#0′ is, for example, a read command or a non-data command, said another command CMD #0′ may be a read command designating an LBA different from CMD #0.

By monitoring an address of access to the host IF 122, the command set monitoring unit 130 can detect that a command stored in SQ #0 has been rewritten. Upon detecting that the command has been rewritten, the command set monitoring unit 130 notifies the host processing unit 114 that the command has been rewritten. Upon receiving the notification, the host processing unit 114 discards data corresponding to the CMD #0 stored in the buffer 300 (S1202).

The above description is similarly applied to discarding of the data stored in the buffer 300 for the read-modify-write described in the third embodiment.

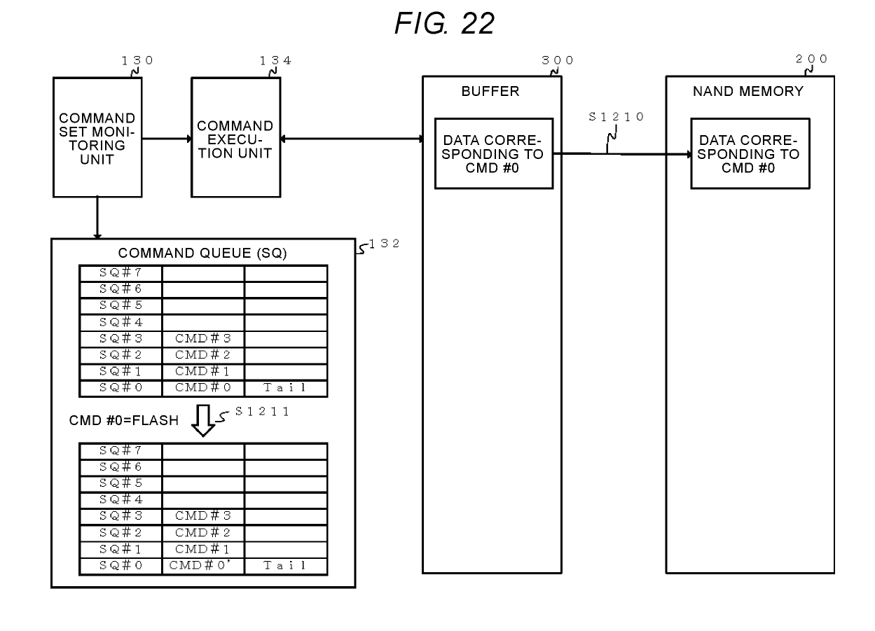

In an example illustrated in FIG. 22, as described in the second embodiment, in regard to CMD #0 (flush command) stored in SQ #0 of the submission queue 132, the corresponding data is written in the NAND memory 200 before the SQ Tail doorbell is written (S1210).

At this time, a case where the host 20 rewrites a command of SQ #0 into another command CMD #0′ is considered. In this case, the storage device 10 does not perform any special operation on the data. As described in the second embodiment, this is because the write data stored in the buffer 300 may be written into the NAND memory 200 not only according to the flush command, but also during the idling of the storage device 10. Further, this is because, when the data is invalidated, it is sufficient to invalidate the data on the logical-to-physical address conversion table.

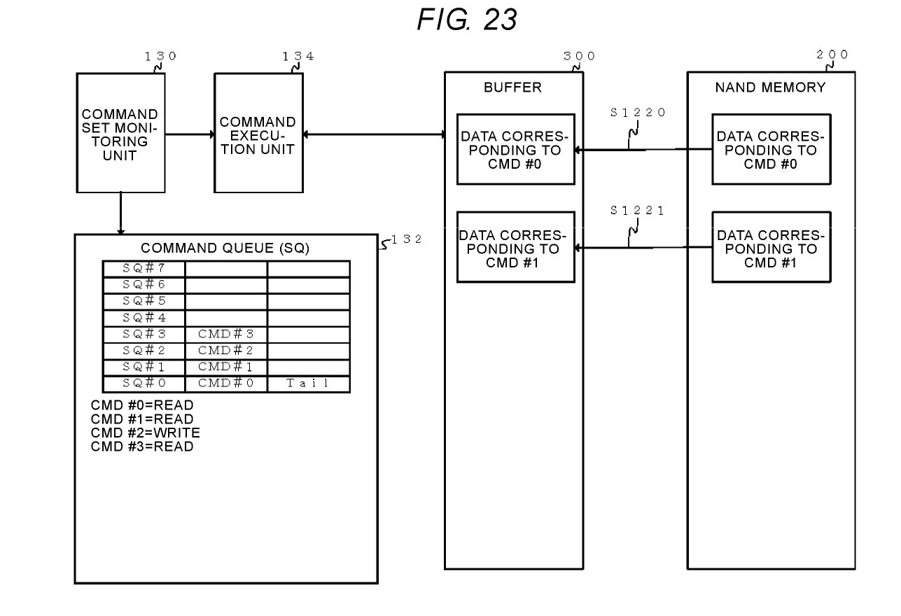

In an example illustrated in FIG. 23, as described in the first embodiment, in regard to CMD #0 (read command) stored in SQ #0 of the submission queue 132 and CMD #1 (read command) stored in SQ #1 of the submission queue 132, the corresponding data are stored in the buffer 300 before the SQ Tail doorbell is written (S1220 and S1221).

On the other hand, CMD #2 (write command) is stored in SQ #2. At this time, the host processing unit 114 does not start execution of a read command (CMD #3) stored in SQ #3 in advance. This is because the execution of the write command of CMD #2 may change the contents of data targeted by the read command of CMD #3. Note that when there is no overlap between the range of logical address specified by CMD #2 and the range of logical address specified by CMD #3, CMD #3 may be executed in advance.

According to the memory device of the fourth embodiment described above, since an appropriate process maybe performed when a command, for which execution has been started, is rewritten, it is possible to improve the performance of the storage device.

According to the storage device of at least one of the above-described embodiments, since the execution of an execution step required for command execution is started prior to reception of a command issue notification, it is possible to improve the performance of the storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A storage device comprising:
a command storage area in which a command is written;
a command issuance notification area in which a notification that a command has been issued is written;
a nonvolatile storage device configured to store data; and
a controller configured to control an access to the nonvolatile storage device in response to the command from a host,
wherein, upon detecting that a first command is written in the command storage area, the controller executes a first step required for execution of the first command before a notification that the first command has been issued is written in the command issuance notification area.

2. The storage device according to claim 1, wherein, when the first command is a read command to read data from the nonvolatile storage device, the controller issues a read request to read data to the nonvolatile storage device, as the first step.

3. The storage device according to claim 1, further comprising a buffer configured to store data temporarily,
wherein, when the first command is a read command to read data from the nonvolatile storage device, the controller stores the data read from the nonvolatile storage device in the buffer, as the first step.

4. The storage device according to claim 3, wherein, when the notification that the first command has been issued is written in the command issuance notification area, the controller transmits the read data stored in the buffer to the host.

5. The storage device according to claim 1, further comprising a buffer configured to store data temporarily,
wherein the controller stores data received from the host in the buffer in connection with a write command, and, when the first command is a flush command to write the data stored in the buffer into the nonvolatile storage device, the controller issues a write request to write the data stored in the buffer into the nonvolatile storage device, as the first step.

6. The storage device according to claim 1, further comprising a buffer configured to store data temporarily,
wherein the controller stores data received from the host in the buffer in connection with a write command, and, when the first command is a flush command to request write the data stored in the buffer into the nonvolatile storage device, the controller writes the data stored in the buffer into the nonvolatile storage device, as the first step.

7. The storage device according to claim 1, wherein, when the first command is a write command to write data into the nonvolatile storage device, the controller issues a read request to read data to the nonvolatile storage device, as the first step.

8. The storage device according to claim 7, wherein the controller performs data transfer with the nonvolatile storage device according to a minimum unit size of data transfer and, when data to be written into the nonvolatile storage device according to the write command has a size that is less than the minimum unit size, the controller issues a read request to read a minimum unit size of data to the nonvolatile storage device, as the first step.

9. The storage device according to claim 8, wherein, after the notification that the first command has been issued is written in the command issuance notification area, the controller receives data to be written from the host.

10. The storage device according to claim 1, further comprising a buffer configured to store data temporarily,
wherein the controller performs data transfer with the nonvolatile storage device according to a minimum unit size of data transfer and, when the first command is a write command to write data into the nonvolatile storage device and data to be written into the nonvolatile storage device according to the write command has a size that is less than the minimum unit size, the controller reads a minimum unit size of data from the nonvolatile storage device and stores the read data in the buffer, as the first step.

11. The storage device according to claim 10, wherein, after the notification that the first command has been issued is written in the command issuance notification area, the controller receives data to be written from the host.

12. A storage device comprising:
a nonvolatile storage device configured to store data; and
a controller configured to control an access to the nonvolatile storage device,
wherein, after receiving a command from a host and before receiving a command issuance notification from the host, the controller starts to execute the command.

13. The storage device according to claim 12, wherein
the controller includes a command submission queue and a command issuance notification area, and
the host first writes the command in the submission queue and then writes a pointer to a tail of the submission queue in the command issuance notification area.

14. The storage device according to claim 13, wherein the controller stars to execute the command between the time the host writes the command in the submission queue and the time the host writes the pointer to the tail of the submission queue in the command issuance notification area.

15. A method of accessing a nonvolatile storage device comprising:
detecting that a first command from a host has been written in a submission queue at a first point in time;
detecting that a notification of the first command being issued from the host has been written in a command issuance notification area at a second point in time; and
upon detecting that the first command is written in the submission queue between the first and second points in time, executing a first step required for execution of the first command before the second point in time.

16. The method according to claim 15, wherein, when the first command is a read command to read data from the nonvolatile storage device, a read request to read data is issued to the nonvolatile storage device, as the first step.

17. The method according to claim 16, further comprising:
transmitting the data read from the nonvolatile storage device to the host after detecting that the notification has been written in the command issuance notification area.

18. The method according to claim 15, further comprising:
storing data received from the host in connection with a write command in a buffer, wherein
when the first command is a flush command to write the data stored in the buffer into the nonvolatile storage device, a write request to write the data stored in the buffer into the nonvolatile storage device is issued, as the first step.

19. The method according to claim 15, wherein, when the first command is a write command to write data into the nonvolatile storage device, a read request to read data from the nonvolatile storage device is issued to the nonvolatile storage device, as the first step.

20. The method according to claim 19, wherein, the host transmits the data to be written in connection with the write command after the notification that the first command has been issued is written in the command issuance notification area.
